(19) United States
(12) Patent Application Publication
(10) Pub. No.: US 2026/0184136 A1
(43) Pub. Date: Jul. 2, 2026

(54) SYSTEM AND METHOD FOR TRAILER VENTING

(71) Applicant: Torc Robotics, Inc., Blacksburg, VA (US)

(72) Inventors: Maximilian Koeper, Ostfidern (DE); Stefan Koch, Pforzheim (DE)

(21) Appl. No.: 19/001,977

(22) Filed: Dec. 26, 2024

(51) Int. Cl. B60H 1/00

(52) U.S. Cl. CPC B60H 1/00835; B60H 1/00364; B60H 1/00771; B60H 1/008

(57) ABSTRACT

A system for trailer venting is provided. The vent is provided in one or more of the walls of the trailer, and is movable between an open vent position, a closed vent position or a vent position between the open and the closed positions. A processing device in communication with the vehicle and the vent performs trailer venting operations that include determining a type of cargo in the cargo chamber, and executing instructions stored in a memory with the processing device to perform vent positioning operations. The operations include accessing a current position of the vent and, based on data including at least the type of cargo in the cargo chamber, selectively positioning the vent to any of the vent open position, the vent closed position or the vent position between the open and closed vent positions while the vehicle is in motion.

### TECHNICAL FIELD

The field of the disclosure relates to trailer venting and, in particular, to a system that automatically adjusts a vent position for a trailer to ensure optimized venting based on information relating to cargo in the trailer.

### BACKGROUND

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, braking and acceleration.

Autonomous vehicles (as well as non-autonomous or semi-autonomous vehicles) that operate with a trailer can transport a variety of cargo. Based on the type of cargo being transported, certain ventilation requirements may be needed to ensure freshness of the cargo is maintained. For example, for produce (such as potatoes and onions), ventilation may be needed to prevent early spoilage caused by hot stagnant air in the trailer. As a further example, backhaul loads generally involve cargo being transported back to the point of origin and, in some instances, may involve transport without refrigeration. Mold and mildew can grow in these conditions if proper ventilation is not provided.

Traditional trailers can include a vent door formed in one of the walls and/or the rear doors of the trailer. The vent door generally includes a latch and is capable of being opened to allow for ventilation of the interior of the trailer. However, such traditional vent doors are operated manually by the driver, necessitating that the driver exit the vehicle and selectively open or close the vent door. The vent door is maintained in the open position until the driver decides to close it, which may not be an adequate amount of time to sufficiently vent the interior of the trailer. Further, if the vent door is in the open position while the vehicle is moving along a route and the external environment air quality is substandard, air contaminants can enter the trailer and may affect the cargo.

Accordingly, there exists a need for a system and a method of trailer venting that automatically adjusts a position of a vent door based on cargo requirements and detected conditions, thereby ensuring that adequate ventilation is provided to the cargo. These and other needs are met by the exemplary system for trailer venting discussed herein.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

In one aspect, an exemplary computer-implemented method for trailer venting is provided. In particular, an exemplary computer-implemented method for changing a position of a vent provided in a trailer is provided. The trailer is configured to be selectively coupled to a vehicle and moved with the vehicle. The trailer includes a front wall, a rear wall, and first and second sidewalls that each extend between the front wall and the rear wall, the front and rear walls and sidewalls define a cargo chamber. The vent (e.g., at least one vent) is movable between an open vent position, a closed vent position or a vent position between the open and the closed positions. The vent is provided in one of the front wall, rear wall or sidewalls. A processing device is in communication with the vehicle and the vent. The method includes determining a type of cargo in the cargo chamber, and executing instructions stored in a memory with the processing device to perform vent positioning operations. The operations include accessing a current position of the vent and, based on data including at least the type of cargo in the cargo chamber, selectively positioning the vent to any of the vent open position, the vent closed position or the vent position between the open and closed vent positions while the vehicle is in motion.

In some embodiments, the operations can include determining existence of an extreme weather condition around the vehicle. The extreme weather condition can include at least one of high winds, precipitation conditions, or arid conditions. The vehicle can include one or more sensors. The vent positioning operations can include detecting a wind speed with the one or more vehicle sensors to determine if the high winds exist around the vehicle. The vehicle can include a global navigation satellite system. The vent positioning operations can include determining the existence of precipitation conditions or arid conditions to determine if the vehicle is currently traveling or will be traveling through an area experiencing precipitation conditions or arid conditions. Upon the determination of the existence of the extreme weather condition around the vehicle, the vehicle positioning operations can include basing vent positioning operations on data related to the existence of the extreme weather condition.

In some embodiments, the operations can include determining existence of a high pollution condition around the vehicle with one or more sensors. The vehicle can include a global navigation satellite system, and the vent positioning operations can include detecting the high pollution condition to determine if the vehicle is currently traveling or will be traveling through an area of high pollution. Upon the determination of the existence of the high pollution condition around the vehicle, the vent positioning operations can include basing vent positioning operations on data related to the existence of the high pollution condition around the vehicle.

In some embodiments, the operations can include determining the existence of one or more condition parameters inside and outside of the cargo chamber of the trailer, and selectively positioning the vent based additionally on the data relating to the condition parameter data relating to conditions inside and outside of the cargo chamber. The trailer can include one or more sensors. The vent positioning operations can include detecting the one or more condition parameters to determine if the one or more condition parameters exist inside and outside the cargo chamber. Upon the determination of the existence of the one or more condition parameters inside and outside the cargo chamber, the vent positioning operations can include basing vent positioning operations on data related to the existence of the one or more condition parameters.

In some embodiments, the vent can be selectively positioned to be about, e.g., 0-10% open, 10-25% open, 25-50% open, 50-75% open, 75-100% open, or the like. The vent can be disposed in the rear wall, the front wall, the first sidewall and/or the second sidewall of the trailer. The vehicle can include one or more sensors, and the vent positioning operations can include detecting with the one or more sensors an area around the vehicle (e.g., a tunnel or bridge) for changing the vent position to the open position, the closed position or the vent position between the open and close vent positions while the vehicle is in motion. The vehicle can include a global navigation satellite system, and the vent positioning operations can include detecting with the global navigation satellite system an area the vehicle is traveling through (e.g., a tunnel or bridge) for changing the vent position to the open position, the closed position or the vent position between the open and closed vent positions while the vehicle is in motion.

In another aspect, an exemplary system for changing a position of a vent disposed in a trailer is provided. The trailer is configured to be selectively coupled to a vehicle and moved with the vehicle. The trailer includes a front wall, a rear wall, and first and second sidewalls that each extend between the front wall and the rear wall, the front and rear walls and sidewalls define a cargo chamber. The system includes the vent, movable between an open vent position, a closed vent position or a vent position between the open and the closed positions, provided in one of the front wall, the rear wall, or sidewalls of the trailer. The system includes a processing device in communication with the vehicle and the vent. The processing device is configured to receive signals and execute instructions stored in a memory to perform vent positioning operations that include accessing a current position of the vent. Based on data including at least a type of cargo in the trailer, the operations include selectively positioning the vent to any of the vent open position, the vent close position or the vent position between the open and closed vent positions while the vehicle is in motion.

In some embodiments, the data can include an existence of an extreme weather condition around the vehicle, and the vehicle positioning operations can include basing vent positioning operations on the data related to the existence of the extreme weather condition around the vehicle. In some embodiments, the data can include an existence of a high pollution condition around the vehicle, and the vehicle positioning operations can include basing vent positioning operations on the data related to the existence of the high pollution condition around the vehicle. In some embodiments, the data can include an existence of one or more condition parameters inside, outside, or both inside and outside of the cargo chamber of the trailer, and the vehicle positioning operations can include basing venting positioning operations on the data relating to the one or more condition parameters relating to conditions inside, outside, or both inside and outside of the cargo chamber.

In some embodiments, the vehicle can include one or more sensors and a global navigation satellite system. In some embodiments, the trailer can include one or more sensors for detecting conditions inside of the cargo chamber. In some embodiments, the vehicle can be, e.g., an autonomous vehicle, a semi-autonomous vehicle, or a non-autonomous vehicle.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic perspective view of an autonomous truck.

FIG. 2 is a schematic perspective view of an autonomous truck and trailer.

FIG. 3 is a schematic side view of an autonomous truck and trailer.

FIG. 4 is a block diagram of the autonomous truck shown in FIGS. 1-3.

FIG. 5 is a block diagram of an example computing system.

FIG. 6 is a block diagram of an exemplary system for trailer venting.

FIG. 7 is a flowchart of a method for trailer venting.

FIG. 8 is a rear view of a trailer including a vent.

FIG. 9 is a side view of a truck and trailer including ventilation fans.

FIG. 10 is a side view of a trailer including ventilation fans.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

The exemplary system for trailer venting discussed herein relies on specific cargo information and sensor data to regulate a position of the vent associated with a trailer to ensure that adequate ventilation and air circulation is provided within the trailer. The system can automatically adjust the vent position in real-time to avoid early spoilage of cargo typically caused by hot stagnant air, and to maintain the conditions within the trailer at the desired level. Each type of cargo can have specific ventilation requirements based on industry standards and/or owner requests/specifications. These ventilation requirements can be input into the system and the system adjusts operation of the vent to ensure the ventilation requirements are met.

The system can include a variety of sensors to assist with accurate and precise venting operation. In some embodiments, the system can include environmental sensors that detect conditions external to the trailer (such as humidity, temperature, rain/no rain, wind speed, air quality, or the like), and adjusts the vent position based on these detected conditions. For example, if high temperatures are detected, the system can adjust operation of the vent to allow for greater ventilation of the trailer. As a further example, if the air quality outside of the trailer is substandard (e.g., due to environmental gas leaks, airborne contaminants in the air, or the like), the system can automatically close the vent until the environmental conditions are detected to be within acceptable levels. In some embodiments, the system can include sensors within the trailer that detect conditions within the trailer (such as humidity, temperature, air circulation speed, or the like, and adjusts the vent position based on these detected conditions. Thus, in some embodiments, the system can rely on sensor data for internal and external factors/conditions to adjust ventilation for optimal performance.

In some embodiments, the system can receive weather data (such as current weather data and future weather data), thereby anticipating the type of weather to be encountered along a mission route. For example, the anticipated weather data can indicate that the vehicle is going to travel through a storm in which humidity is elevated. As a further example, the anticipated weather data can indicate that the temperature will be at either extreme hot or cold levels. Based on the anticipated weather, the system can automatically adjust the vent to prepare for the anticipated weather conditions. As a further example, if the anticipated weather indicates that rain is expected, the system can adjust for ventilation before rain begins to avoid or minimize moisture entering the trailer. In some embodiments, the system can use a planned mission route to adjust operation of the vent position. For example, if the vent is in the open position and the system detects that the vehicle is about to pass through a tunnel where air quality may be substandard (e.g., due to vehicle exhaust), the system can automatically close the vent until the vehicle has passed out of the tunnel.

In some embodiments, the trailer can include a cooling unit and one or more ventilation fans formed in the walls of the trailer. The processing device of the system can be communicatively connected to the cooling unit and/or the ventilation fans and can automatically adjust operation of the cooling unit and/or the ventilation fans to ensure proper air circulation and/or temperatures are maintained within the trailer. For example, based on, e.g., cargo information, sensor data regarding external conditions, anticipated weather data, mission route, combinations thereof, or the like, the system can adjust operation of the fans to adequately ventilate the trailer. The system can operate the on/off status of the fans, as well as the level of operation to control the airflow speed and/or volume within the trailer.

The system operates automatically without manual intervention, e.g., from a driver for non-autonomous or semi-autonomous vehicles. Further, the system operates automatically during travel of the vehicle along its mission route and does not necessitate stopping of the vehicle to adjust the position of the vent. The sensors of the system can transmit signals to a processing device which, in turn, is communicatively connected to a mechanism for adjusting operation of the vent. This feedback loop allows for automatic and real-time (or substantially real-time) control of the vent in an accurate and precise manner, optimizing ventilation of the trailer. The precise adjustments to the vent position are not merely an open or closed position, but rather a specific position of the vent (e.g., 0-10% open, 10-25% open, 25-50% open, 50-75% open, or 75-100% open, or the like), ensuring optimal ventilation is achieved.

In some embodiments, the vent can be in the form of a door with a latch and a hydraulic or mechanical assembly/arm that extends and retracts to allow for selective opening and closing of the vent door. In some embodiments, the vent can be in the form of a radial louver with openings, and the system can adjust the radial position of a rotatable cover to selectively expose openings for ventilation. In some embodiments, the vent can be in the form of louvers adjustable to pivot for increasing or decreasing an overall opening area.

In some embodiments, the vent can be in the form of adjustable louvers, including slats which can be selectively adjusted by the adjustment mechanism to control airflow. The adjustable louvers can be useful for trailers carrying temperature-sensitive or moisture-sensitive goods. In some embodiments, the vent can be in the form of rotating louvers designed to align with the wind direction for optimal ventilation, and the adjustment mechanism can rotate the louvers to optimize ventilation. In some embodiments, the vent can be in the form of axial fans with louvers, which combine mechanical fans with protective louvers to actively circulate air within the trailer. In some embodiments, the vent can be in the form of humidity-control louvers, which include features to limit moisture ingress while allowing airflow. In some embodiments, the vent can be in the form of filtered vents, which include filters behind the louvers to keep out dust and small particles, as well as optional insect and/or dust filter/screens. In some embodiments, the vent can be in the form of thermostatic vents, which use thermostatic controls to adjust vent opening based on the temperature of inside the trailer. In some embodiments, the vent can be formed from, e.g., aluminum (lightweight and corrosion-resistant), stainless steel (offers higher strength and longevity), high-density plastic (cost-effective and weather-resistant for basic ventilation needs), combinations thereof, or the like.

In some embodiments, the system can operate as a safety notification system. For example, if the system detects that sufficient ventilation cannot be provided to meet the cargo ventilation requirements, the system can issue an alert to, e.g., a user interface within the vehicle, mission control, combinations thereof, or the like, indicating that rectification is needed to avoid cargo loss. As a further example, if the system detects an issue with the cargo, such as a fire in the trailer, the system can shut down the ventilation system and issue an alert to mission control (and/or local authorities).

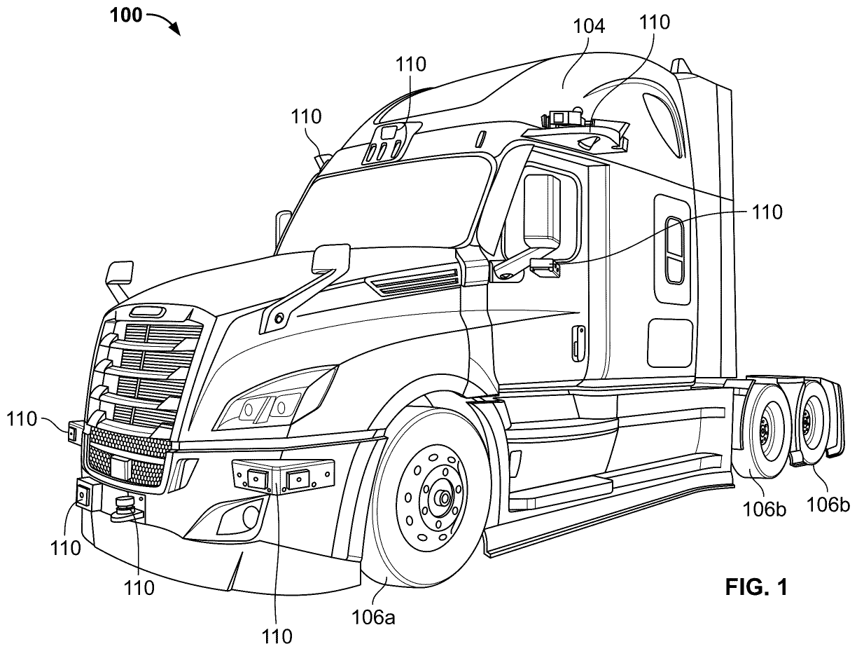

Various embodiments in the present disclosure are described with reference to FIGS. 1-10 below.

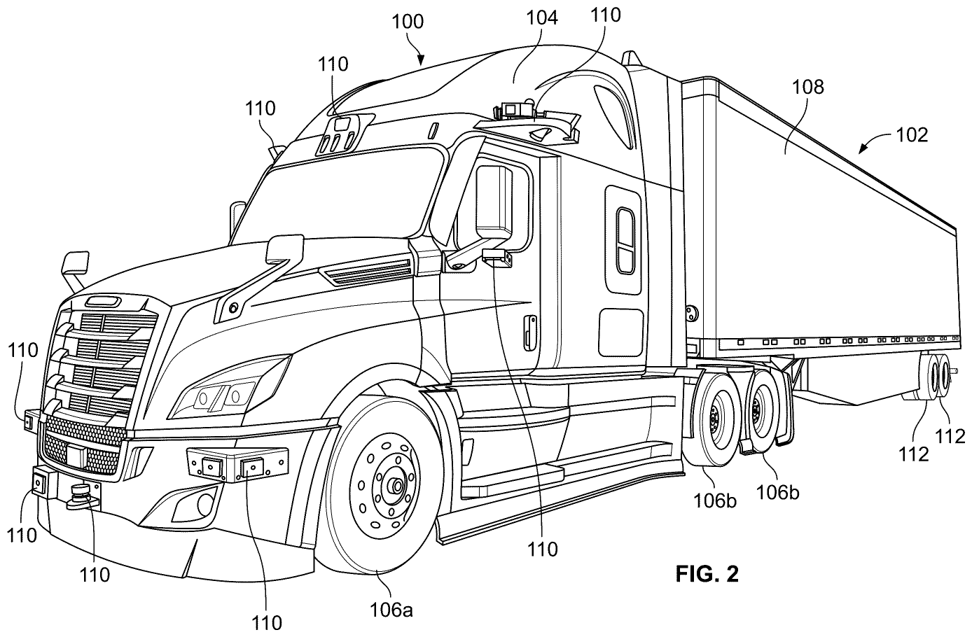

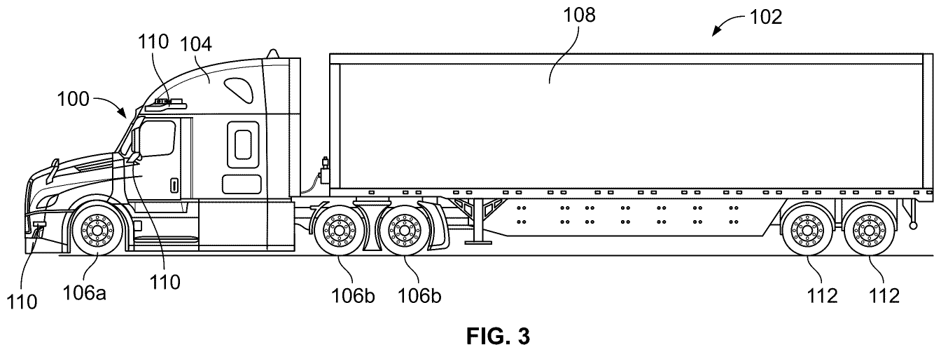

FIG. 1 is a perspective view of a vehicle 100, such as a truck that may be conventionally connected to a single or tandem trailer 102 to transport the trailer 102 to a desired location, as shown in FIGS. 2 and 3, which are, respectively, perspective and side views of the vehicle 100 of FIG. 1 with the trailer 102 attached thereto. The vehicle 100 includes a cabin 104 that can be supported, and steered in the required direction, by front wheels 106a and rear wheels 106b that are partially shown in FIG. 1. The front wheels 106a are positioned by a steering system that includes a steering wheel and a steering column (not shown). The steering wheel and the steering column may be located in the interior of cabin 104.

The vehicle 100 may be an autonomous vehicle, in which case the vehicle 100 may omit the steering wheel and the steering column to steer the vehicle 100. Rather, the vehicle 100 may be operated by an autonomy computing system of the vehicle 100 based on data collected by a sensor network including one or more sensors, e.g., sensors 110 shown in FIGS. 1-3. The vehicle 100 may additionally include a fifth-wheel coupling (not shown) to which the trailer 102 can be releasably attached. The trailer 102 can include a storage container 108 and a plurality of rear wheels 112 that support the storage container 108. It should be understood that in some embodiments the vehicle 100 and the trailer 102 can be a permanently attached as a single unit.

The sensors 110 have a field-of-view at the front, sides and/or rear of the vehicle 100. Similar sensors 110 can be used around the perimeter of the vehicle 100 to ensure full environmental coverage around the vehicle 100 is provided by the sensors 110. In some embodiments, the vehicle 100 can include, e.g., 5-6 LIDAR sensors, 8-10 cameras, combinations thereof, or the like. In some embodiments, the vehicle 100 can tow a trailer 102 and the trailer 102 can similarly include LIDAR sensors and/or cameras to provide field-of-view coverage around the perimeter of the vehicle 100 and the trailer 102. The environmental coverage by the sensors and/or cameras therefore provides data corresponding with the front, rear, sides and corners of the vehicle 100 and the trailer 102 hauled by the vehicle 100.

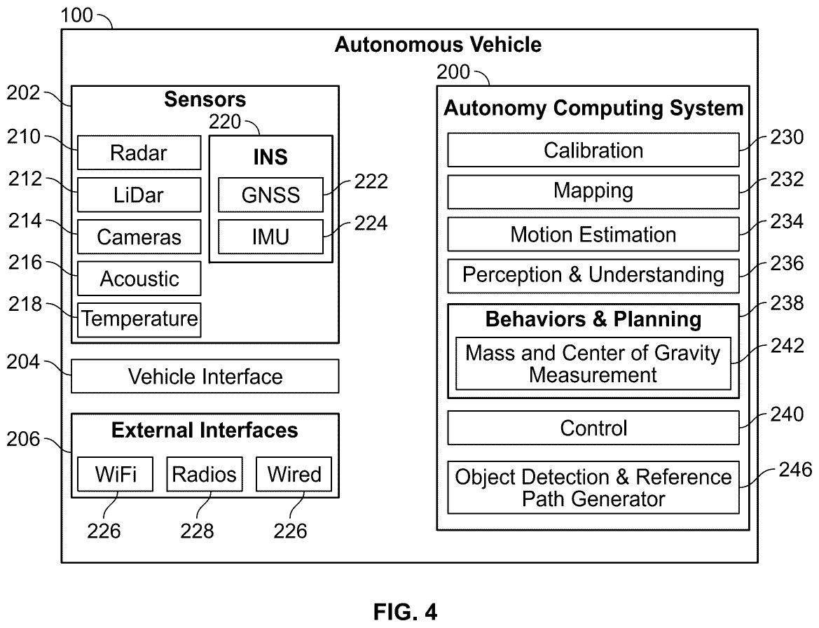

FIG. 4 is a block diagram representing autonomous vehicle 100 shown in FIGS. 1-3. In the example embodiment, autonomous vehicle 100 generally includes autonomy computing system 200, sensors 202, a vehicle interface 204, and external interfaces 206. It should be understood that the sensors 110 on the vehicle 100 in FIGS. 1-3 and described herein correspond to the sensors identified as 202 in FIG. 4. The sensors 110 may specifically comprise any of the sensors 210-220 shown in FIG. 4 and described herein.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify one or more construction markers in the environment surrounding autonomous vehicle 100. In some embodiments, the image data generated by cameras 214 may be sent to autonomy computing system 200 or other aspects of autonomous vehicle 100 for one or more of identifying objects around the vehicle 100, updating a reference path based on the detected objects, and controlling operation of the vehicle 100 to guide the vehicle 100 along its route.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100. In some embodiments, the trailer associated with the vehicle 100 can include similar sensors 202 for gathering similar data associated with the trailer, thereby further assisting with control operations of the autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 226, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a mass and center of gravity measurement module 242, a control module or controller 240, and an object detection and reference path generator module 246. The object detection and reference path generator module 246, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

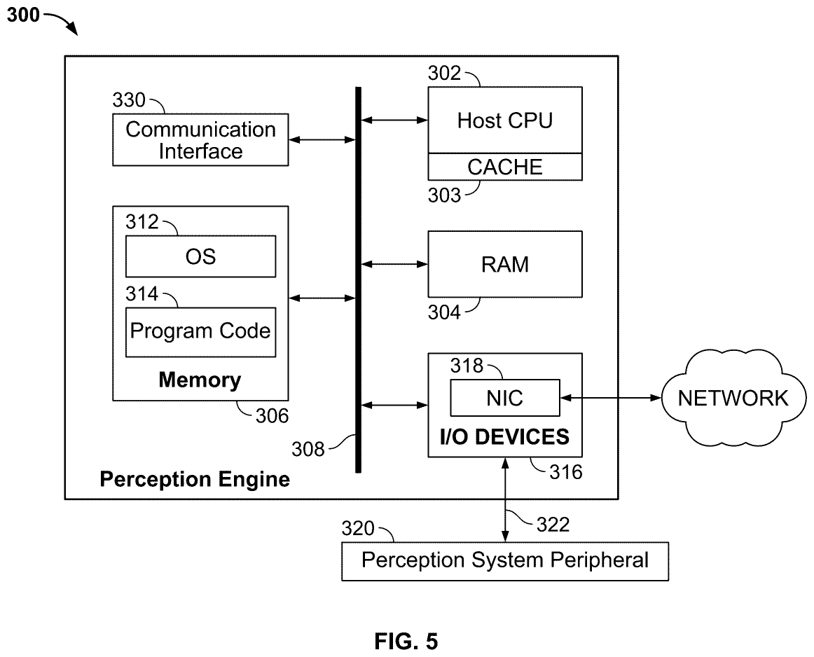

FIG. 5 is a block diagram of an example computing system 300, such as the autonomy computing system 200 shown in FIG. 4, configured for sensing an environment in which an autonomous vehicle is positioned. Computing system 300 includes a CPU 302 coupled to a cache memory 303, and further coupled to RAM 304 and memory 306 via a memory bus 308. Cache memory 303 and RAM 304 are configured to operate in combination with CPU 302. Memory 306 is a computer-readable memory (e.g., volatile, or non-volatile) that includes at least a memory section storing an OS 312 and a section storing program code 314. Program code 314 may be one of the modules in the autonomy computing system 200 shown in FIG. 4. In alternative embodiments, one or more sections of memory 306 may be omitted and the data stored remotely. For example, in certain embodiments, program code 314 may be stored remotely on a server or mass-storage device and made available over a network 332 to CPU 302.

Computing system 300 also includes I/O devices 316, which may include, for example, a communication interface such as a network interface controller (NIC) 318, or a peripheral interface for communicating with a perception system peripheral device 320 over a peripheral link 322. I/O devices 316 may include, for example, a GPU for image signal processing, a serial channel controller or other suitable interface for controlling a sensor peripheral such as one or more acoustic sensors, one or more LiDAR sensors, one or more cameras, or a CAN bus controller for communicating over a CAN bus.

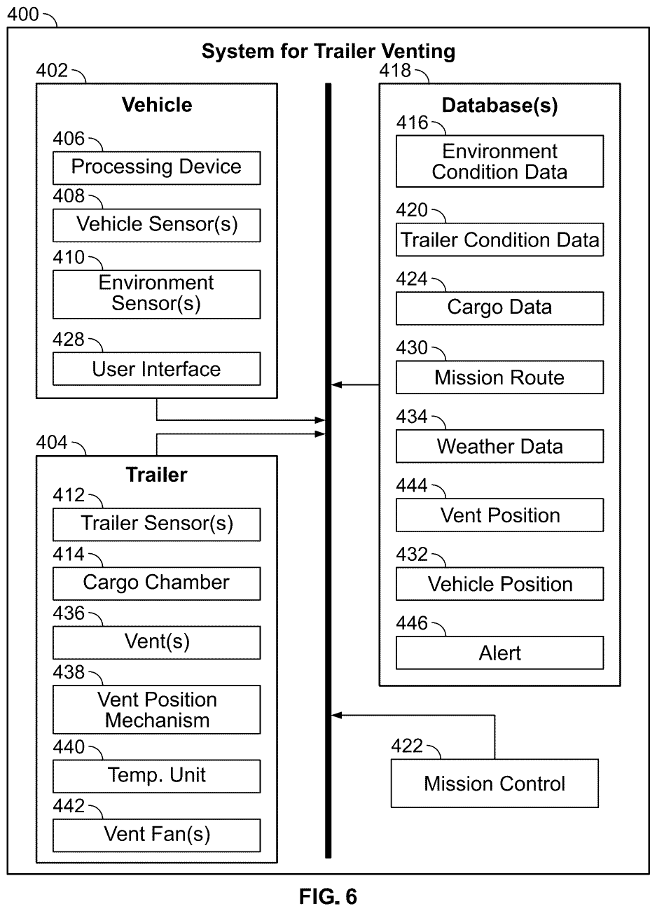

FIG. 6 is a block diagram of an exemplary system 400 for trailer venting. The system 400 generally includes one or more vehicles 402 (e.g., autonomous vehicle 100) and a trailer 404 (e.g., trailer 102) associated with the respective vehicles 402. Each vehicle 402 includes a processing device 406 (e.g., computing system 200, computing system 300, or the like) configured to receive and process data for regulating venting of the trailer 404. The vehicle 402 includes sensors 408 (e.g., sensors 202) that can perceive conditions internal to the vehicle 402, including components of the vehicle 402, as well as perceiving objects external to the vehicle 402 to assist with movement of the vehicle 402 along the mission route. In some embodiments, the sensors 408 can include a global navigation satellite system and associated data.

The vehicle 402 further includes environment sensors 410 (e.g., sensors 202) configured to detect and gather data in real-time (or substantially real-time) relating to the environment surrounding the vehicle 402, e.g., temperature, humidity, wind speed, rain/no rain, air quality, or the like. In some embodiments, the system 400 can consider wind speeds in combination with the speed of the vehicle 402. For example, one or more of the ventilation features for the trailer 404 can include wind powered ventilation. These ventilation systems can use wind-driven turbines to circulate air, and are generally more effective when the vehicle 402 is moving and/or when there is a breeze. Such systems can be considered “passive ventilation” and rely on natural airflow. If the vehicle 402 is located in a traffic situation where minimal movement and/or airflow exists, the system 400 can rely on powered ventilation features, such as electric fans.

In some embodiments, the environment sensors 410 can be used to gather data relating to, e.g., daytime vs nighttime UV exposure, fog, altitude, air quality, pollution, or the like. Regarding the daytime vs nighttime UV exposure, prolonged exposure to sunlight can increase the interior temperature of the trailer 404, leading to overheating. Regarding fog, high moisture levels during foggy conditions can increase the risk of condensation. Regarding altitude, in high altitude areas, lower air pressure can affect the flow of air through ventilators, reducing their effectiveness. Increased risk of condensation also occurs due to temperature fluctuations between day and night and high altitudes. Regarding air quality, dust and particulates can be detected. In dusty environments, such as deserts or construction zones, particulates can enter the trailer 404 and contaminate goods. Regarding pollution, ventilation systems can block out polluted air, especially when transporting sensitive items. The environment conditions are therefore detected by the sensors 410 and used by the system 400 to appropriately adjust operation of the ventilation for the trailer 404. For example, venting can be reduces or stopped if a high risk of condensation or pollutants is detected.

In some embodiments, the trailer 404 can include trailer sensors 412 configured to detect and gather data in real-time (or substantially real-time) relating to the conditions inside of the trailer 404, i.e., the cargo chamber 414 formed by the walls and/or doors of the trailer 404. The sensors 412 can detect, e.g., temperature, humidity, airflow/circulation speeds, moisture, air quality, condensation, UV exposure, fog, altitude, air quality, pollution, or the like.

The trailer 404 can be selectively coupled to the vehicle 402 and moved with the vehicle 402. The trailer 404 includes a front wall, a rear wall, and first and second sidewalls that each extend between the front wall and the rear wall, the front and rear walls and sidewalls defining the cargo chamber 414. In some embodiments, the walls of the trailer 404 can include or be entirely formed by one or more doors. In some embodiments, the rear wall of the trailer 404 can include or be entirely formed by one or more doors. Thus, the term “wall” as used herein refers to both a structure lacking a door and a structure including one or more doors.

In some embodiments, at least some of the data received by the processing device 406 can be data from the environment sensors 410, and the system 400 can regulate venting of the trailer 404 solely based on data from the sensors 410. In some embodiments, at least some of the data received by the processing device 406 can be data from the trailer sensors 412, and the system 400 can regulate venting of the trailer 404 solely based on data from the sensors 412. In some embodiments, at least some of the data received by the processing device 406 can be data from both the environment sensors 410 and the trailer sensors 412, and the system 400 can compare and/or weigh the data to regulate venting of the trailer 404. For example, based on temperature and/or humidity readings in the environment around the vehicle 402 and/or within the trailer 404, the processing device 406 can initiate action for increasing or decreasing venting of the trailer 404, or can maintain the same level of venting. The data gathered by the environment sensors 410 can be transmitted and electronically stored as environment condition data 416 in one or more databases 418 (e.g., memory 306). The data gathered by the trailer sensors 412 can be transmitted and electronically stored as trailer condition data 420 in the one or more databases 418.

The one or more databases 418 can be configured to receive and electronically store additional data for operation of the system 400, including but not limited to data from the sensors 408, 410, 412. In some embodiments, the database 418 can be stored externally from the vehicle 402 and the vehicle 402 can be in communication with the external database 418 for receiving and/or transmitting data associated with the system 400. For example, the database 418 can be located at mission control 422, which can be in communication with the vehicle 402. In some embodiments, the database 418 can be located on the vehicle 402 itself.

The database 418 can electronically store a variety of data to assist with operation of the system 400. For example, cargo data 424 can be input into the system 400 regarding details of the cargo being transported in the trailer 404. This information can include, e.g., the type of cargo, the location of the cargo within the trailer 404, the amount of cargo, the starting point and destination of the cargo, the conditions in which the cargo should be maintained during transport in the trailer 404, if the cargo includes hazardous materials (which may need specialized ventilation to release any potential build-up of gases), combinations thereof, or the like. The trailer 404 conditions for transport of the cargo can include the preferred, e.g., temperature level or range, humidity level or range, moisture level or range, air circulation level or range, combinations thereof, or the like.

In some embodiments, the cargo conditions can be automatically input into the system 400 when the cargo is scanned and placed in the cargo chamber 414 for transport. In some embodiments, the cargo conditions can be input into the system 400 via a user interface at, e.g., mission control 422, at a loading hub, a graphical user interface 426 at the vehicle 402, or the like. In some embodiments, the cargo conditions can be based on industry standards for the type of cargo being transported. In some embodiments, the cargo conditions can be specified by the manufacturer of the products/items being transported. In some embodiments, the cargo conditions can be custom requested by a party involved in shipping, transporting and/or purchasing the cargo.

In some embodiments, the ventilation systems need to comply with regulations based on local climate conditions or carto type, such as the need for exhaust vents when transporting hazardous or flammable materials. As non-limiting examples, below are standards for transporting perishable goods, hazardous materials, pharmaceuticals, livestock, sensitive electronics, bulk materials, waste and recyclable materials, refrigerated and climate-controlled trailers, animals for research or zoo, and emergency or disaster relief goods, although it should be understood that other transportation standards can be used depending on the type of cargo being transported.

Transporting Perishable Goods Regulation: As an example, HACCP (Hazard Analysis and Critical Control Points) or FSMA (Food Safety Modernization Act) in the U.S. requires controlled ventilation to maintain temperature and humidity levels for food safety. Cargo conditions for fresh produce require proper air circulation to maintain freshness and prevent spoilage. Meat or seafood must stay within specified temperature ranges, with ventilation ensuring even cooling.

Transporting Hazardous Materials Regulation: As an example, ADR (European Agreement concerning the International Carriage of Dangerous Goods by Road) or 49 CFR (Code of Federal Regulations) in the U.S. provides relevant standards. Trailers carrying hazardous materials (e.g., flammable gases, chemicals) must have ventilation systems to prevent the build-up of fumes or gases. Cargo conditions for flammable liquids requires vents to release vapor pressure build-up safely. Compressed gases need ventilation to dissipate any accidental leaks. Corrosive materials must avoid moisture accumulation, as it can react with chemicals.

Transporting Pharmaceuticals Regulation: As an example, Good Distribution Practice (GDP) or FDA Guidelines for Pharmaceuticals Transport provide relevant standards. The standards require maintaining a stable environment to ensure product efficacy and safety. Cargo conditions for vaccines require strict temperature and humidity control, with ventilation ensuring consistent air distribution in refrigerated trailers. Medical supplies are sensitive to temperature fluctuations and moisture.

Transporting Livestock Regulation: As an example, Animal Welfare Regulations or EU Council Regulation (EC) No 1/2005 provide relevant standards. The standards require adequate ventilation to provide fresh air and remove heat and moisture generated by animals. Cargo conditions for cattle or poultry require ventilation systems that prevent heat stress and provide fresh air during long journeys. Horses need controlled airflow to reduce stress and maintain a stable environment.

Transporting Sensitive Electronics Regulation: As an example, IEC (International Electrotechnical Commission) Standards or industry-specific guidelines can be used. These standards require protection from moisture, dust, and temperature extremes. Cargo conditions including maintaining semiconductors in low-humidity environments. Battery packs require ventilation to prevent overheating and manage off-gassing risks (e.g., lithium-ion batteries).

Transporting Bulk Materials (Grains, Fertilizers, Etc.) Regulation: As an example, OSHA Guidelines or National Grain and Feed Association (NGFA) provide relevant standards. Ventilation is required to prevent dust accumulation, which can lead to explosions, and to control moisture that can spoil bulk materials. Cargo conditions for grains require ventilation to prevent mold growth and spoilage. Fertilizers need ventilation to prevent moisture-related caking or chemical reactions.

Transporting Waste or Recyclable Materials Regulation: Local environmental protection laws (e.g., EPA in the U.S.) provide relevant standards. Ventilation is required to minimize odors, reduce fire risks, and prevent gas buildup. Cargo conditions for organic waste requires vents to release gases like methane. Industrial waste needs ventilation to dissipate fumes or odors safely.

Refrigerated and Climate-Controlled Trailers Regulation: ATP (Agreement on the International Carriage of Perishable Foodstuffs) in Europe or ISO 1496/2 Standards in the U.S. provide relevant standards. The standards ensure consistent temperature and airflow for climate-sensitive cargo. Cargo conditions for frozen foods require even airflow to maintain freezing temperatures throughout the trailer. Flowers need controlled humidity to maintain freshness without mold.

Transporting Animals for Research or Zoos Regulation: IATA Live Animal Regulations for international transport or local wildlife transport rules provide relevant standards. Ventilation is crucial for maintaining air quality and stress reduction. Cargo conditions for exotic animals includes a need for a controlled environment tailored to their native habitats. Laboratory animals require precise airflow to ensure health and compliance with ethical standards.

Emergency or Disaster Relief Goods Regulation: Guidelines from organizations like UNICEF, WHO, or FEMA provide relevant standards. Ventilation must protect sensitive supplies like medicines, tents, or food from damage during transportation. Cargo conditions for dry foods include the need for moisture protection. Emergency shelters require ventilation to avoid mildew during transit. Summary of key regulatory aspects ventilation system requirements include preventing buildup of harmful gases, protecting against water ingress while allowing airflow, and maintaining cargo-specific temperature and humidity levels. Monitoring systems include data loggers for temperature and humidity tracking. Alarms for unsafe conditions in hazardous cargo transport can be used.

In some embodiments, the database 418 can receive and store data relating to the mission route 430. For example, the mission route 430 can include the roads taken and to be taken by the vehicle 402 in transporting the cargo in the trailer 404. The mission route 430 can include details regarding the roads to be traveled, including bridges and/or tunnels along the route 430. The database 418 can further include information regarding the vehicle position 432 along the mission route 430. This information can be helpful in determining whether ventilation of the trailer 404 should be initiated, continued or stopped. For example, if the system 400 determines from the mission route 430 and the vehicle position 432 that the vehicle 402 is about to travel through a tunnel, the system 400 can temporarily stop venting of the trailer 404 until the vehicle 402 exits the tunnel to avoid intake of airborne contaminants from vehicle exhaust. By using the mission route 430 for purposes of regulating venting operation, the system 400 ensures that the quality of the air within the trailer 404 or being circulated through the trailer 404 is at an optimal level.

In some embodiments, the database 418 can receive and store data relating to weather data 434. The weather data 434 can include the current weather conditions around the vehicle 402, such as humidity, temperature, wind speed, air quality, precipitation (rain, snow fog), pollution, UV exposure (day vs night), altitude, or the like. The current weather conditions can be used to regulate the venting operations for the trailer 404 to adjust for the existing conditions around the trailer 404. In some embodiments, the weather data 434 can include the expected or forecasted weather conditions along the mission route 430. This forecasted data can be used by the system 400 to anticipate the expected conditions and to adjust venting operations for the trailer 404 in preparation for the expected weather conditions. For example, if heavy rain is expected, the system 400 can initiate or continue venting operations before rain begins, and stop venting when rain begins to avoid moisture entry into the trailer 404. As a further example, if rain and high humidity is expected, the system 400 can initiate or continue venting operations until the rain and/or high humidity conditions begin, and subsequently stops venting to avoid entry of moisture and/or humid air into the trailer 404.

The trailer 404 can include one or more venting features/mechanisms. In some embodiments, one or more walls (or doors) of the trailer 404 can include a vent 436 (e.g., a vent door) capable of being selectively opened and closed. A vent position mechanism 438 can be coupled to the vent 436 and can be in communication with the processing device 406 for selective operation and positioning of the vent 436. In some embodiments, the mechanism 438 can be in the form of an electronic, motorized or hydraulic arm configured to change the pivot angle of the vent 436 relative to the wall/door of the trailer 404. However, it should be understood that any mechanism known in the industry could be used to regulate opening and closing of the vent 436. In some embodiments, the vent 436 can be in the form of a circular base plate with openings and a cover plate that rotates relative to the circular base plate. In such embodiments, the mechanism 438 can selectively rotate the cover plate to expose openings leading into the trailer 404 for venting. In some embodiments, the vent 436 can be in the form of a fixed ventilation. In some embodiments, the vent 436 can be in the form of a static and non-controllable ventilator. In some embodiments, the vent 436 can be a side wall ventilator, a roof ventilator, a solar powered fan, a rain hook, a turbine vent (wind powered), panels with insect and/or dust screens, combinations thereof, or the like.

The mechanism 438 can be used to move the vent 436 into a fully open position, a closed position, or any position in-between, based on the desired amount of airflow/ventilation. In some embodiments, the mechanism 438 can be used to selectively move and position the vent 436 at, e.g., 0-10% open, 10-25% open, 25-50% open, 50-75% open, or 75-100% open, or the like. For example, based on at least one of the environment condition data 416, the trailer condition data 420, the cargo data 424, the mission route 430, the weather data 434, or the vehicle position 432, the system 400 can determine if additional ventilation is needed, if less ventilation is needed, or if the current level of ventilation should be adjusted. The system 400 can detect the vent position 444 (e.g., via a position sensor) and uses the position 444 data to selectively operate the mechanism 438 for adjusting the position of the vent 436 to achieve the desired ventilation level. This vent 436 position adjustment can be performed automatically and in real-time (or substantially real-time) while the vehicle 402 is moving along the mission route 430.

In some embodiments, the trailer 404 can include a temperature unit 440 configured to either cool or heat the cargo chamber 414. For example, the temperature unit 440 can be in the form of a refrigeration unit configured to maintain a certain temperature within the cargo chamber 414. As a further example, the temperature unit 440 can be in the form of a heating unit configured to maintain a certain temperature within the cargo chamber 414. The temperature to be maintained in the chamber 414 can be dependent on at least the cargo data 424, although the mission route 430, the weather data 434 and the vehicle position 432 can be used as well. For example, if particularly high temperatures are expected along the mission route 430 based on the weather data 434, the temperature unit 440 can be actuated to provide additional cooling in preparation for the higher temperatures, thereby ensuring that the desired temperature level for the cargo (based on the cargo data 424) is maintained even when the temperatures rise at a later time. The system 400 therefore preemptively adjusts operation of the temperature unit 440 (or any other venting feature of the trailer 404) to ensure the cargo condition requirements are met.

In some embodiments, the trailer 404 can include one or more vent fans 442. The vent fans 442 can be installed in one or more of the walls and/or doors of the trailer 404. For example, the trailer 404 can include a vent fan 442 on the roof, the side walls, and/or the rear door. For example, similar to operation of the temperature unit 440, based on at least one of the environment condition data 416, the trailer condition data 420, the cargo data 424, the mission route 430, the weather data 434, or the vehicle position 432, the system 400 can determine if additional ventilation is needed, if less ventilation is needed, or if the current level of ventilation should be adjusted. Depending on this determination, the system 400 can actuate operation of one or more vent fans 442 to maintain the desired cargo condition requirements in the trailer 404. For example, the vent fans 442 can be regulated to circulate more air, circulate less air, or maintain the current air circulation.

As discussed herein, the system 400 operates automatically to adjust the ventilation of the trailer 404 in real-time (or substantially real-time), thereby optimizing the conditions within the cargo chamber 414. Compared to traditional venting of the trailer 404 where manual operation of the vent 436 is needed, the exemplary system 400 provides the necessary amount of venting of the trailer 400 based on existing conditions in the environment and/or trailer 404, and can adjust venting operation based on anticipated weather and/or route conditions. In addition, the system 400 can react to environmental changes in real-time to avoid damage to the cargo (something a manual operation cannot achieve). For example, if the environment sensors 410 detect pollution in the air, the system 400 can automatically stop venting and close all vents 436 to avoid infiltration of polluted air/contaminants into the trailer 404. In contrast, a manual operation may not be performed until after the polluted air has already infiltrated the cargo chamber 414. The system 400 therefore provides an advantageous operation for venting of the trailer 404 and ensuring the cargo reaches its destination in optimal conditions. The exemplary system 400 ensures that environmental conditions do not negatively impact trailer 404 contents, by quickly modifying the vent(s) to a position required to minimize the negative impact of any ambient conditions relative to the vehicle 402. The vent position(s) may be modified when the vehicle 402 is moving to enable the efficient and immediate modification of vent positions.

In some embodiments, the system 400 can operate as a safety feature for the vehicle 402 and/or trailer 404. For example, if the system 400 detects that ventilation of the cargo chamber 414 is inadequate and the venting features are incapable of being actuated to sufficiently vent the chamber 414, the system 400 can issue an alert 446 to the user interface 428 of the vehicle 402 and/or mission control 422 with a request for correction. Similarly, if the system 400 detects a problematic situation in the chamber 414, e.g., a fire, smoke, or the like, the system 400 can automatically shut down all venting features to avoid spreading of the situation, and issues the alert 446.

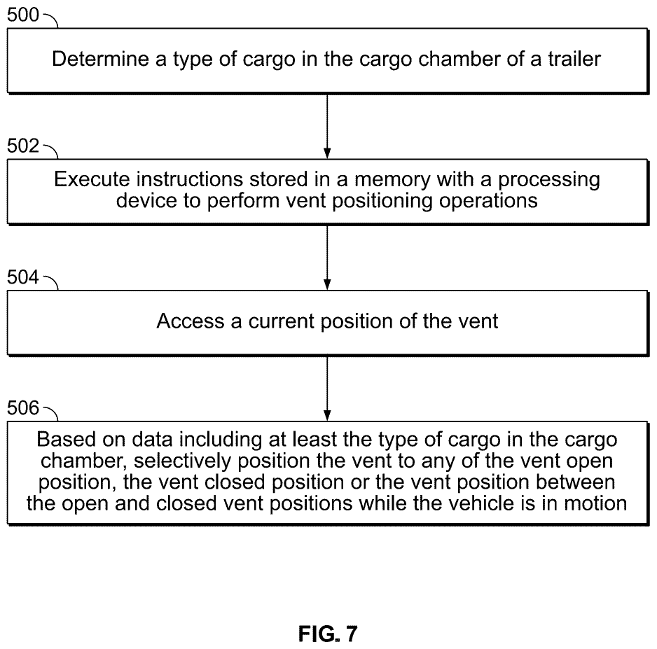

FIG. 7 is a flowchart of a method of trailer venting by the exemplary system 400 discussed herein. At 500, the system determines a type of cargo in the cargo chamber of the trailer. At 502, instructions stored in a memory are executed with a processing device to perform vent positioning operations. At 504, a current position of the vent is accessed or detected. At 506, based on data including at least the type of cargo in the cargo chamber, the system selectively positions the vent to any of the vent open position, the vent closed position, or the vent position between the open and closed vent positions while the vehicle is in motion.

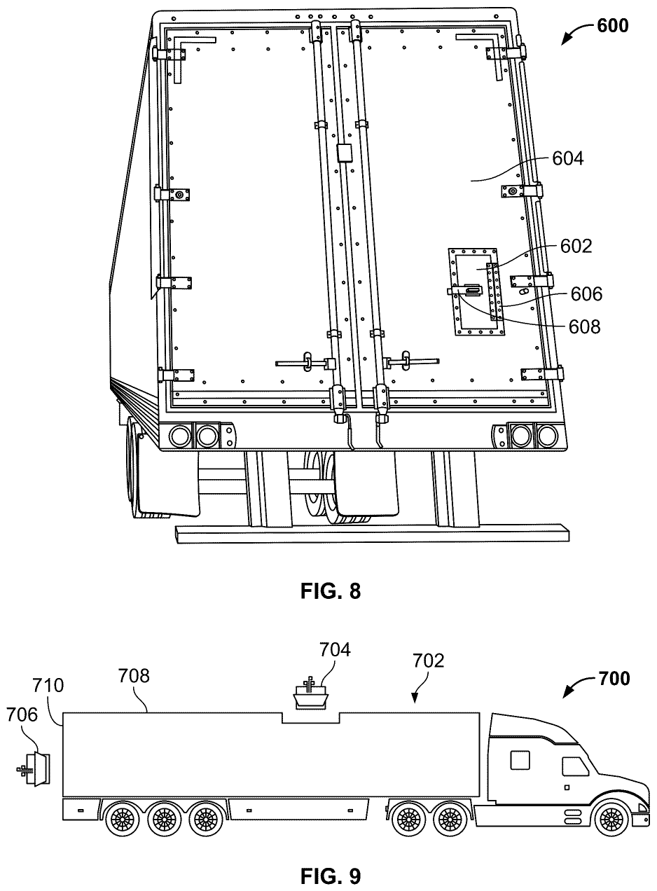

FIG. 8 is a rear view of a trailer 600 (e.g., trailer 102) including a vent 602 in the form of a door. The vent 602 can be movably coupled to the door 604 of the trailer 600 via a hinge 606, and can include a latching mechanism 608 for selectively opening and closing of the vent 602. The latching mechanism 608 can be coupled to a mechanism (e.g., vent position mechanism 438) configured to be selectively regulate opening and closing of the vent 602, as well as the amount of opening of the vent 602. It should be understood that a similar vent 602 can be located on any of the walls of the trailer 600, and could be operated in substantially the same manner.

FIG. 9 is a side view of a truck 700 (e.g., vehicle 100) and a trailer 702 (e.g., trailer 102), including ventilation fans 704, 706 associated with the trailer 702. As non-limiting examples, the trailer 702 can include a ventilation fan 704 installed on a roof 708 of the trailer 702, and a ventilation fan 706 installed on a rear door 710 of the trailer 702. The ventilation fans 704, 706 can be independently operated based on data collected by the exemplary system regarding the conditions around the trailer 710, conditions within the trailer 710, cargo information/requirements, weather data, route data, vehicle 700 position data, combinations thereof, or the like. Note that the ventilation fans 704, 706 may be located along walls 108.

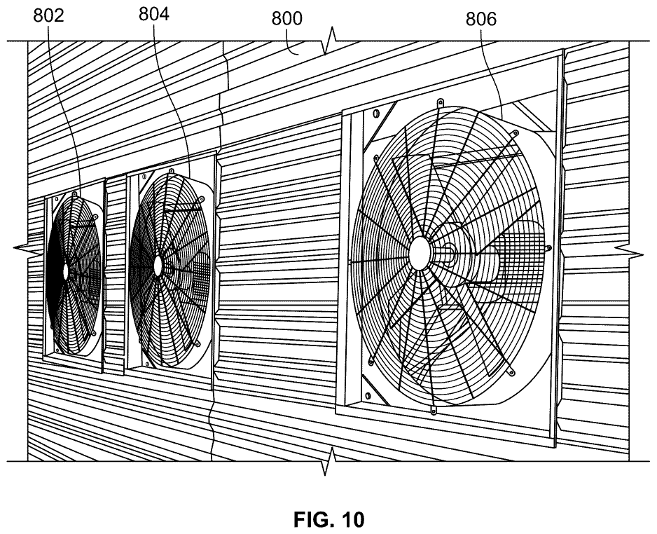

FIG. 10 is a side view of a trailer 800 (e.g., trailer 102) including multiple ventilation fans 802, 804, 806. The fans 802-806 can be selectively and independently regulated with or without operation of additional ventilation features of the trailer 800 to maintain the desired ventilation conditions for the cargo being transported in the trailer 800.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A computer-implemented method for changing a position of a vent provided in a trailer, wherein the trailer is configured to be selectively coupled to a vehicle and moved with the vehicle, and wherein the trailer comprises a front wall, a rear wall, and first and second sidewalls that each extend between the front wall and the rear wall, the front and rear walls and sidewalls define a cargo chamber, and the vent, movable between an open vent position, a closed vent position or a vent position between the open and the closed positions, provided in one of the front wall, rear wall or sidewalls; and a processing device in communication with the vehicle and the vent, the method comprising:
determining a type of cargo in the cargo chamber; and
executing instructions stored in a memory with the processing device to perform vent positioning operations comprising:
accessing a current position of the vent, and
based on data comprising at least the type of cargo in the cargo chamber, selectively positioning the vent to any of the vent open position, the vent closed position or the vent position between the open and closed vent positions while the vehicle is in motion.

2. The computer-implemented method of claim 1, further comprising determining existence of an extreme weather condition around the vehicle, wherein the extreme weather condition comprises at least one of high winds, precipitation conditions, or arid conditions.

3. The computer-implemented method of claim 2, wherein the vehicle comprises one or more sensors, and the vent positioning operations further comprise detecting a wind speed with the one or more vehicle sensors to determine if the high winds exist around the vehicle; and the vehicle comprises a global navigation satellite system, wherein the vent positioning operations further comprise determining the existence of precipitation conditions or arid conditions to determine if the vehicle is currently traveling or will be traveling through an area experiencing precipitation conditions or arid conditions.

4. The computer-implemented method of claim 2, wherein upon the determination of the existence of the extreme weather condition around the vehicle, the vehicle positioning operations comprise basing vent positioning operations on data related to the existence of the extreme weather condition.

5. The computer-implemented method of claim 1, further comprising determining existence of a high pollution condition around the vehicle with one or more sensors.

6. The computer-implemented method of claim 5, wherein the vehicle includes a global navigation satellite system, and the vent positioning operations comprise detecting the high pollution condition to determine if the vehicle is currently traveling or will be traveling through an area of high pollution.

7. The computer-implemented method of claim 5, wherein upon the determination of the existence of the high pollution condition around the vehicle, the vent positioning operations comprise basing vent positioning operations on data related to the existence of the high pollution condition around the vehicle.

8. The computer implemented method of claim 1, further comprising determining the existence of one or more condition parameters inside and outside of the cargo chamber of the trailer, and selectively positioning the vent based additionally on the data relating to the condition parameter data relating to conditions inside and outside of the cargo chamber.

9. The computer-implemented method of claim 8, wherein the trailer includes one or more sensors, and the vent positioning operations comprise detecting the one or more condition parameters to determine if the one or more condition parameters exist inside and outside the cargo chamber.

10. The computer-implemented method of claim 8, wherein upon the determination of the existence of the one or more condition parameters inside and outside the cargo chamber, the vent positioning operations comprise basing vent positioning operations on data related to the existence of the one or more condition parameters.

11. The computer-implemented method of claim 1, wherein the vent is selectively positioned to be 0-10% open, 10-25% open, 25-50% open, 50-75% open, or 75-100% open.

12. The computer-implemented method of claim 1, wherein the vent is disposed in the rear wall, the front wall, the first sidewall and/or the second sidewall of the trailer.

13. The computer-implemented method of claim 1, wherein the vehicle comprises one or more sensors, and the vent positioning operations comprise detecting with the one or more sensors an area around the vehicle for changing the vent position to the open position, the closed position or the vent position between the open and close vent positions while the vehicle is in motion.

14. The computer-implemented method of claim 1, wherein the vehicle comprises a global navigation satellite system, and the vent positioning operations comprise detecting with the global navigation satellite system an area the vehicle is traveling through for changing the vent position to the open position, the closed position or the vent position between the open and closed vent positions while the vehicle is in motion.

15. A system for venting of a trailer, wherein the trailer is configured to be selectively coupled to a vehicle and moved with the vehicle, and wherein the trailer comprises a front wall, a rear wall, and first and second sidewalls that each extend between the front wall and the rear wall, the front and rear walls and sidewalls define a cargo chamber, the system comprising:
a vent, movable between an open vent position, a closed vent position or a vent position between the open and the closed positions, provided in one of the front wall, the rear wall, or sidewalls of the trailer; and
a processing device in communication with the vehicle and the vent, wherein the processing device is configured to receive signals and execute instructions stored in a memory to perform vent positioning operations comprising:
accessing a current position of the vent, and
based on data comprising at least a type of cargo in the trailer, selectively positioning the vent to any of the vent open position, the vent close position or the vent position between the open and closed vent positions while the vehicle is in motion.

16. The system of claim 15, wherein the data comprises an existence of an extreme weather condition around the vehicle, and the vehicle positioning operations comprise basing vent positioning operations on the data related to the existence of the extreme weather condition around the vehicle.

17. The system of claim 15, wherein the data comprises an existence of a high pollution condition around the vehicle, and the vehicle positioning operations comprise basing vent positioning operations on the data related to the existence of the high pollution condition around the vehicle.

18. The system of claim 15, wherein the data comprises an existence of one or more condition parameters inside, outside, or both inside and outside of the cargo chamber of the trailer, and the vehicle positioning operations comprise basing venting positioning operations on the data relating to the one or more condition parameters relating to conditions inside, outside, or both inside and outside of the cargo chamber.

19. The system of claim 15, wherein the vehicle comprises one or more sensors and a global navigation satellite system.

20. The system of claim 15, wherein the trailer comprises one or more sensors for detecting conditions inside of the cargo chamber.
